(19) United States
(12) Patent Application Publication
(10) Pub. No.: US 2019/0343184 A1
(43) Pub. Date: Nov. 14, 2019

(54) INHALATION DEVICES WITH DOSAGE METERING AND COMPATIBLE WITH STANDARD CONNECTION SYSTEMS

(71) Applicant: INDOSE INC., Woodland Hills, CA (US)

(72) Inventors: Daniel FREEMAN, Agoura, CA (US); Ari Freeman, Lafayette, CA (US); Jacqueline Freeman, Lafayette, CA (US)

(73) Assignee: INDOSE INC., Woodland Hills, CA (US)

(21) Appl. No.: 16/515,860

(22) Filed: Jul. 18, 2019

Related U.S. Application Data
(63) Continuation-in-part of application No. 15/244,518, filed on Aug. 23, 2016.
(60) Provisional application No. 62/388,066, filed on Jan. 13, 2016.
(60) Provisional application No. 62/386,615, filed on Dec. 7, 2015.
(60) Provisional application No. 62/386,614, filed on Dec. 7, 2015.

(51) Int. Cl. A24F 47/00; G05B 19/4155; G01F 13/00

(52) U.S. Cl. CPC A24F 47/008; G05B 2219/37375; G01F 13/006; G05B 19/4155

(57) ABSTRACT

An inhalation device for inhaling a vaporized substance that includes metering capabilities to inform a user when a particular amount of substance has been consumed is provided with a connector structure compatible with standard battery units, such as 510 or 710 thread connections, so that a user can obtain an economical dosage-controlled device by, e.g., simply swapping out the vaporization cartridge of a standard vape. The inhalation device includes a timer to control the amount of time of heater activation to permit dosage control during use of the inhalation device, or a timer can be used in combination with other dosage measuring techniques.

### RELATED APPLICATION DATA

This application is a continuation in part of U.S. application Ser. No. 15/244,518, filed on Aug. 23, 2016, which claims priority from U.S. Provisional Patent Application Nos. 62/386,614 and 62/386,615, both of which were filed on Dec. 7, 2015, and 62/388,066, which was filed on Jan. 13, 2016. These applications are incorporated by reference herein.

### BACKGROUND

Inhaling devices such as vaporizers, vaporizing pens, and vaporizing machines are used to vaporize substances such as tobaccos, oils, liquids, medical drugs, and plant herbs. Once vaporized, these substances are then inhaled by consumers. Such inhaling devices have health benefits over traditional smoking methods. But inhaling the vapor can have negative effects on the body depending on the substance, such as nicotine. Inhaling devices have become more popular with consumers, but pose problems.

For example, while vaporizers can be safer than traditional smoking methods, it is difficult to meter the amount of vaporized substance that is being inhaled. So a user of an inhalation device that vaporizes nicotine may actually consume more nicotine than had the user smoked cigarettes or cigars.

There are multiple factors that affect the quantity of drug that is inhaled. These factors include the drug concentration of the vaporized substance, the amount of vapor inhaled, the duration of inhalation, variations between inhalation devices, and variation and inconsistency in the functionality of the device.

Another issue is that the inhaled substances may have different effects on different users depending on various factors. To optimize a user's experience, it is necessary to track the quantity inhaled taken over time and track the resulting effect it has on that user. This can be a tedious and demanding task. Typical users may not keep track of each dose and record the experience.

### SUMMARY

In one aspect, this disclosure describes an inhalation device for inhaling a vaporized substance that includes a channel through which the vaporized substance can flow, a light signal device, wherein the light signal device emits light; a sensor, wherein the sensor senses the light from the light signal device; and wherein the light signal device and the sensor are positioned in the channel such that the vaporized substance can flow past the sensor and the light signal device.

In another aspect, this disclosure also describes a processor, wherein said processor uses data from the sensor to meter the consumption of the vaporized substance. The inhalation device can also include a sensor, wherein the sensor acquires data relating to airflow in the device. The inhalation device can further include an indicator, wherein the indicator informs the user when a dose of the substance has been inhaled.

In another aspect, this disclosure describes an inhalation device for inhaling a vaporized substance comprising a processor; and a meter, wherein the meter comprises an indicator; wherein the processor, using data from the timer, calculates the amount of the substance inhaled, and wherein the indicator informs the user of the amount that has been inhaled. The inhalation device can further include a mouthpiece, from which a user can inhale a vaporized substance; a reservoir, wherein the substance in unvaporized form is stored; and a heating element, wherein said heating element is used to heat the unvaporized substance.

The inhalation device can also have the capability of the meter indicating a progressive inhalation of the substance including a progressive inhalation of the substance in discrete quantities.

In another aspect, this disclosure describes an inhalation device comprising: a body, wherein the body includes: a mouthpiece, from which a user can inhale a vaporized substance; a reservoir, wherein the substance in unvaporized form is stored; a heating element, wherein said heating element is used to heat the unvaporized substance; and a processor, wherein the processor defines a session; wherein the device is configured such that the unvaporized substance from the reservoir is heated by the heating element to create a vaporized substance and said vaporized substance is inhaled by the user through the mouthpiece; and wherein the processor is configured to keep a session open, during which the processor is configured to stop the heating element when the user stops inhaling, and is configured to start the time and the heating element when the user resumes inhaling.

In another aspect, the disclosure describes a metered inhalation device which is made to be connectible with a standard battery unit, so that a standard, e.g. 510 or 710 thread cartridge can be replaced with a metered dosage cartridge to provide a user with an economical metered inhalation device.

In another aspect of the invention, the disclosure describes a simplified, economical metered dosage cartridge designed to fit a standard, e.g., 510 or 710 thread battery unit, and in which metering is provided by a timed duration of operation of the heating unit and an indication to the user of the end of the timed period.

### DESCRIPTION OF THE DRAWINGS

FIG. 1 is a diagram of an inhalation device.

FIG. 1A is a diagram of a portion of an inhalation device.

FIG. 1B is another diagram of a portion of an inhalation device.

FIG. 2 is another diagram of an inhalation device.

FIG. 3 is another diagram of an inhalation device.

FIG. 4 is another diagram of an inhalation device.

FIG. 5 is another diagram of an inhalation device.

FIG. 6A is another diagram of an inhalation device; FIG. 6B is a diagram of a inhalation device and a battery unit; and FIG. 6C is a diagram of the inhalation device connected to the battery unit.

FIG. 7 is a diagram of a battery unit.

### DETAILED DESCRIPTION

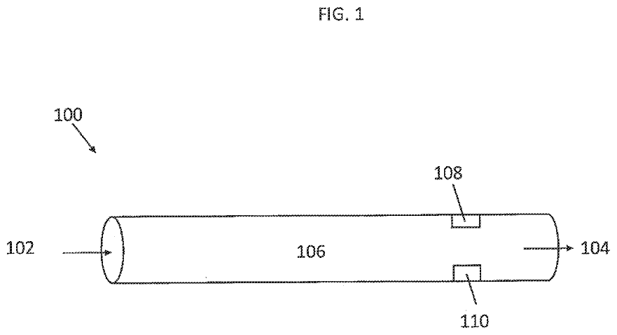

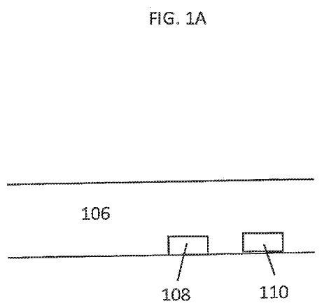

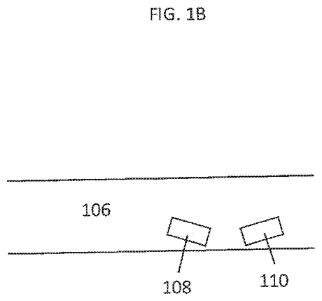

FIG. 1 illustrates an inhalation device 100 for inhaling a vaporized substance. The inhalation device 100 includes a first opening 102 and a second opening 104. In between the two openings is a channel 106. When a user inhales using the inhalation device 100, air flows into the first opening 102 and in the device 100, vaporized substance is created by a heating element (not shown), and a mixture of air and vapor flows through the channel 106 to the second opening 104 and ultimately to the user.

The inhalation device 100 also includes a sensor 108 and a signal 110. The sensor 108 and signal 110 are positioned across from each other in the channel 106. The sensor 108 senses the vapor amount. For example, the sensor 108 can sense the concentration of vapor. The sensor 108 senses the intensity of the signal emitted by the signal 110. If the sensor 108 senses a high signal output, this indicates that the amount of vapor is low, and the vapor/air mixture is dominated by air. Likewise, if the sensor 108 senses a low signal output, this indicates that the vapor/air mixture is dominated by vapor.

Data from the sensor 108 can assist the device 100 in providing information about vapor concentration to the user. For example, if the sensor senses a 5% drop in intensity from the signal 110, that could correlate to a mixture of vapor/air that is 60% vapor. The chart below graphs the value percent drop in an optocell (i.e., a device that senses the intensity of light) versus the percentage of cannabis oil vapor in a mixture of vapor and air:

The chart above shows the correlation between vapor concentration and the readings from an optocell. Knowing the relative concentration of the vapor can assist the device 100 in providing additional information to the user. For example, if a user inhales using the device 100 and the sensor 108 senses a high output, this may indicate that the concentration is less than expected. The device 100 could include an additional indicator to inform the user that the device 100 is not producing the expected amount of vapor. The sensor 108 can be any suitable sensor that senses light including without limitation, a photosensor, photodetector, optocell, optoresistor, optotransistor, optodiode, and/or solar cell. The signal 110 can be any suitable device that produces light, such as an LED. The signal could also emit ultraviolet light. In other words, the signal 110 can produce a wide range of wavelengths of light and the sensor 108 detects those wavelengths of light. The inhalation device 100 can optionally use filters in order to target a specific wavelength of light to optimally detect vapor intensity. Additionally, the reservoir can be configured to connect wirelessly to a mobile device (such as a smartphone), either directly or via the processor 604. This would allow the user to track their drug usage using a mobile application. This connection could take many forms, including; bluetooth, WIFI, cellular, near field radio, transponder and others.

In FIG. 1, the sensor 108 is positioned across from the signal 110. The sensor 108 and the signal 110 can also be positioned in alternative arrangements without departing from the scope of this disclosure. For example, in FIG. 1A the sensor 108 and the signal 110 are positioned next to each other in the channel 106. In another embodiment, shown in FIG. 1B, the sensor 108 and the signal 110 are positioned next to each other at an angle in the channel 106. The arrangements of the sensor 108 and the signal 110 in FIGS. 1A and 1B use concepts of backscatter and fluorescence.

In backscatter, the vapor passing through the channel 106 can “reflect” light back from the perspective of the sensor 110. In this scenario, the vapor particle size would determine the “reflection” properties and angle of refection. In florescence, the light may get absorbed by the vapor particles and a new light may be generated. The new light would then be picked up by the sensor. The light and sensor may be set up facing the same direction (in parallel) towards the channel 106. Other alternative positions of sensor 108 and signal 110 known to persons of ordinary skill in the art whereby the flow of vaporized substance affects the signal received by the sensor from the light produced by the light signal device is intended to fall within the scope of this disclosure. For example, the sensor 108 and the signal 110 may be next to each other but one of the sensor 108 and the signal 110 may also be positioned at an angle.

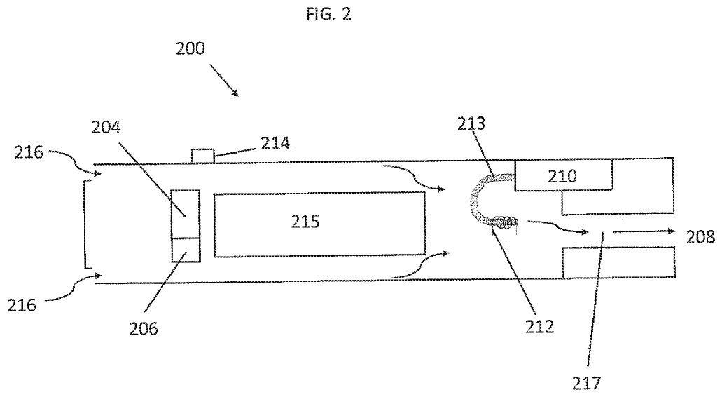

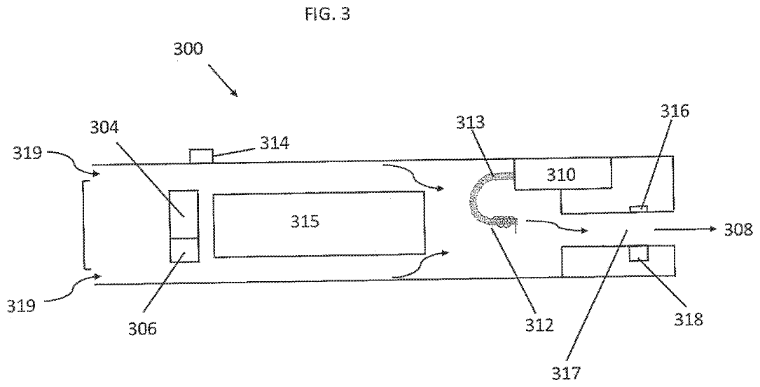

FIG. 2 shows an inhalation device 200. The inhalation device includes a processor 204 and a timer 206. In this embodiment, the inhalation device 200 includes an inlet 216, an outlet 208, a reservoir 210, a heating element 212, and a wick 213. The inhalation device 200 also includes an indicator 214 and a battery 215. The reservoir 210 stores the substance in unvaporized form, and the heating element 212 heats the unvaporized substance from the reservoir 210 via the wick 213 to create a vaporized substance, which is then inhaled by the user through the outlet 208. The device 200 also includes a channel 217 through which the vaporized substance produced by the heating element 212 and air will flow to the outlet 208 when a user inhales.

The device 200 uses the processor 204 and the timer 206 to provide metering information to the user. More specifically, the processor 204 controls the timer 206 such that when a user inhales using the device 200, the processor 204 will start the timer 206 as well as the heating element 212 to begin vaporizing the substance. After the timer 206 has reached a particular value, a particular amount of the vaporized element will have been produced, and the processor 204 will shut off the heating element 212. Alternatively, the processor 204 will not shut off the heating element 212, but rather will send a signal to the indicator 214 that the particular amount of the vaporized element has been consumed.

For example, if the heating element produces 1 mg/second, and the particular amount is 3 mg, the processor will turn on the heating element 212 when a user inhales, and the processor will turn off the heating element when the timer reaches 3 seconds. After the timer reaches 3 seconds, the processor will send a signal to the indicator 214, which will then indicate that the particular amount has been consumed. The indicator 214 can be an audio signal, visual signal, visual display, or a vibration. The indicator 214 could also be a transmitter that sends a signal to an external device such as a smart phone, tablet, or computer indicating that a particular amount has been consumed.

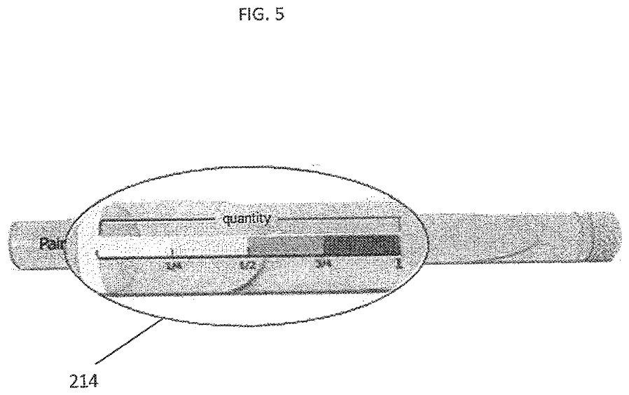

Alternatively, the indicator 214 could display what amount the user has consumed. As shown in FIG. 5, as a visual indicator to the user, the indicator 214 may include a progressive meter indicator. This could take the form of a sequence of lights, possibly LED lights, which indicate the progression of the amount consumed by the user. For example, there could be a sequence of four LED lights on the vaporizer indicating when a %, ½, % and full amount has been taken. When the full amount has been taken, the lights might be programmed to indicate to the user that the full amount has been reached by flashing. The progressive meter indicator could take other forms, like a mechanical indicator, a dial, a screen display, or a sound sequence. The progressive meter indicator may continue to meter and indicate the user beyond one cycle. For example, after a full amount has been taken the indicator will turn all lights off and begin turning on each light again as the user consumes.

In the above example, in which a particular amount is set at 3 mg and the heating element 212 produces 1 mg/second of vapor, 3 mg will be delivered to a user who inhales for 3 seconds. In the event that the user cannot inhale long enough to consume a single dose in a single inhalation, the device 200 is configured to keep a session open, with a session being defined as a particular time within which a can consume the particular amount. A session in this case could be set to 10 seconds. In this open session configuration, the device 200 can stop producing vapor when the user stops inhaling and start producing vapor when the user inhales again. When the sum of the user's inhalations amounts to consumption of 3 mg, the processor will send a signal to the indicator 214. Determining when the user stops inhaling can be achieved by using a pressure sensor. Where the pressure drops below a threshold, the heating element will stop. And when the pressure goes above the threshold, the heating element will resume. Alternatively, instead of time-based, a session can be vapor-based, where the device 200 keeps a session open until a certain quantity of vapor is produced.

FIG. 3 shows an inhalation device 300 according to another embodiment. The inhalation device includes a processor 304 and a timer 306. In this embodiment, the inhalation device 300 includes an inlet 319, an outlet 308, a reservoir 310, a heating element 312, and a wick 313. The inhalation device 300 also includes an indicator 314 and a battery 315. The reservoir 310 stores the substance in unvaporized form, and the heating element 312 heats the unvaporized substance from the reservoir 310 via the wick 313 to create a vaporized substance, which is then inhaled by the user through the outlet 308. The device 300 also includes a channel 317 through which the vaporized substance produced by the heating element 312 and air will flow to the outlet 308 when a user inhales.

The device 300 further includes an indicator 314 that will indicate to the user when a particular amount of the vaporized substance has been consumed. The indicator 314 can be an audio signal, visual signal, visual display, or a vibration. The indicator 314 could also be a transmitter that sends a signal to an external device such as a smart phone, tablet, or computer indicating that a dose has been consumed. Alternatively, the indicator 314 could display what dose the user has consumed.

The inhalation device 300 can also include a sensor 316 and a signal 318, such as an LED that produces a wide range of light wavelengths. The signal could also be one that produces ultraviolet light. The sensor 316 and signal 318 are positioned across from each other in the channel 317. The sensor 316 senses the concentration of the vapor. For example, the sensor 316 can be an optical sensor that senses the intensity of the light produced by the signal 318. If the sensor 316 senses a high output, this indicates that the vapor concentration is low, and the vapor/air mixture is mostly, if not all, air. If the sensor 316 senses a low output, this indicates that the vapor concentration is high. The processor 304 records information from the sensor 316. The sensor 316 can assist the device 100 in providing information about vapor concentration to the user. For example, if the sensor senses a 5% drop in intensity from the signal 110, that could correlate to a mixture of vapor/air that is 60% vapor.

The processor 304 uses data from the sensor 316 to calculate when a particular amount of the vaporized substance has been produced. This is useful where the substance is viscous such as cannabis oil. In such viscous substances the amount of vapor produced for a given time can vary. In the embodiment of FIG. 3, when a user inhales using the device 300, the processor 304 will turn on the heating element 312. The sensor 316 will sense in real time (as a non-limiting example, every 0.1 seconds) the intensity of the light from the signal 318. Using the data from the sensor 316, the processor 304 can determine when a particular amount has been produced.

For example, if a particular amount to be consumed is 3 mg and the heating element 312 vaporizes 1 mg per second, then theoretically the 3 mg should be produced in 3 seconds. In practice, however, it may take longer for the inhalation 300 device to vaporize 3 mg. This may due to factors such as the time it takes the heating element 312 to heat up and the consistency of the drug released from the reservoir 310 to the wick 313. So for example, when a user begins to inhale, the first ten readings of the sensor 316 in the first second (e.g., one reading every 0.1 seconds) may indicate that the vapor produced over the first second is 50% of the expected production. This percentage can be thought of as a vapor factor. The processor 304 will take this vapor factor into account to determine when 3 mg is consumed by the user. In other words, the processor 304 will collect the data from the sensor 316 (e.g., every 0.1 seconds) on the vapor factor to determine when 3 mg has been consumed by the user. For a given time, the processor 304 will multiply the time (e.g., 0.1 seconds) by the vapor factor at that time, and will add each of these products to determine when a particular amount has been consumed. For example, if in the first second of inhalation, 50% of vapor is produced, and assuming 100% of vapor is produced after 1 second, the processor will able to determine that 3 mg has been consumed in 3.5 seconds.

In the above example, the processor 304 is capable of acquiring data from the sensor 316 and also included information on how much a particular amount of substance is expected to be produced per unit of time. The processor 304 can store additional vapor characteristics of the substance. For example, the processor 304 can store the time it takes for the heating element 312 to heat to the temperature at which it vaporizes the substance. The processor 304 can also store the heating and temperature variations during different inhalation profiles. For example, if a user inhales at a high rate, the air flowing through the inlet 319 and into the device 300 can cool the heating element 312. The processor 304 can store information on different rates of inhalation to adjust, for example, the temperature of the heating element 312. The processor 304 can also store information on the flow of drug from the reservoir 310 to the wick 313, the concentration of the substance within a given volume, and the vaporization rates of the substance at different temperatures of the heating element 312. The processor 304 as well as the processors discussed herein can be standard integrated circuit (IC) chips made by IC manufacturers such as Texas Instruments.

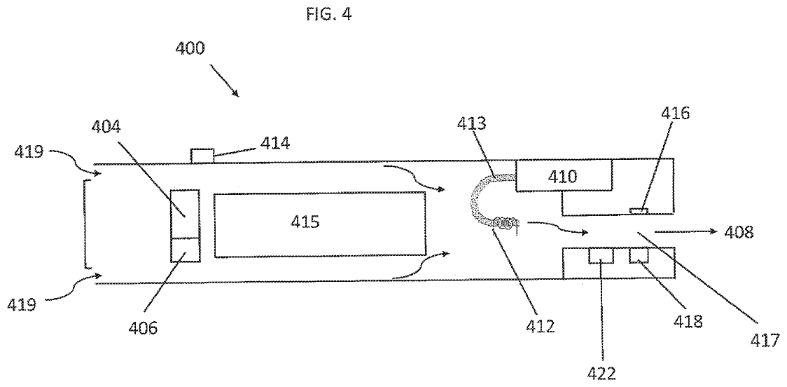

FIG. 4 illustrates another inhalation device 400 according to another embodiment of the disclosure. The inhalation device 400 includes a processor 404 and a timer 406. In this embodiment, the inhalation device 400 includes an inlet 419, an outlet 408, a reservoir 410, a heating element 412, and a wick 413. The device 400 further includes an indicator 414 for informing a user when a dose of the substance has been inhaled. The device 400 also includes a channel 417 through which air and the vaporized substance produced by the heating element 412 flow to the outlet 408 when a user inhales.

The inhalation device 400 also includes a sensor 416 and a signal 418, such as an LED that produces a wide range of light wavelengths. The signal could also be one that produces ultraviolet light. The sensor 416 and signal 418 are positioned across from each other in the channel 417. The sensor 416 senses the concentration of the vapor. For example, the sensor 416 can be an optical sensor that senses the intensity of the light produced by the signal 418 at wavelengths that would include, but not be limited to, visible light and ultraviolet light.

The inhalation device 400 further includes a volume flow sensor 422. The sensor 422 can be any suitable airflow sensor including, but not limited to, any combination or stand-alone of the following: a pressure sensor, a propeller, a microphone or a piezoelectric sensor. The sensor 422 is used to measure the velocity at which the mixture of vapor and air flow through the channel 417. So for example, if the sensor 422 is a propeller, the propeller would be installed in the channel 417 and would spin according to velocity of the vapor/air mixture. The frequency of revolutions can be measured and used to calculate the velocity of the mixture. If the sensor is a microphone, the microphone can be setup in the channel 417 to listen to the noise of the vapor/air mixture passing through the channel. A correlation can be made between the sound intensity and/or frequency to the rate of flow of the mixture. Optionally, the sensor 422 can be placed between the inlet 419 and the processor 404 such that it detects the air flow rate going through the device 400 when a user inhales.

The sensor 422 can be used to adjust the intensity of the heating element 412. The temperature of the heating element can affect the amount of the substance that is vaporized. The sensor 422 is able to sense how intensely a user inhales (i.e., senses the volume per unit time of an inhalation). The processor 404 can acquire this data and adjust the intensity of the heating element by adjusting the voltage of the heating element.

The sensor 422 and the adjustment of the heating element 412 is useful in a non-limiting situation where the user desires to consume a dose more quickly. So for example, if the device 400 is set up so that the heating element produces 1 mg/second of vapor and a dose is 3 mg, a user that inhales at a high volume per unit time can consume the entire dose quicker than 3 seconds. In this scenario, the sensor 422 will be able to sense the higher velocity of the vapor/air mixture, and the processor can increase the intensity of the heating element such that it produces more vapor. The processor 404 can adjust the intensity of the heating element 412 in real time based on data from the sensor 422. So if a user does not inhale intensely, the sensor 422 will detect the decreased flow rate and the processor can then lower the intensity of the heating element 412.

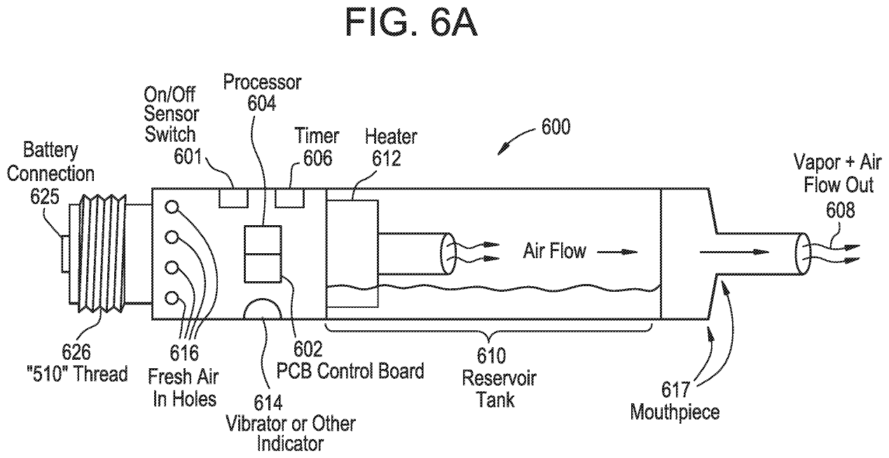

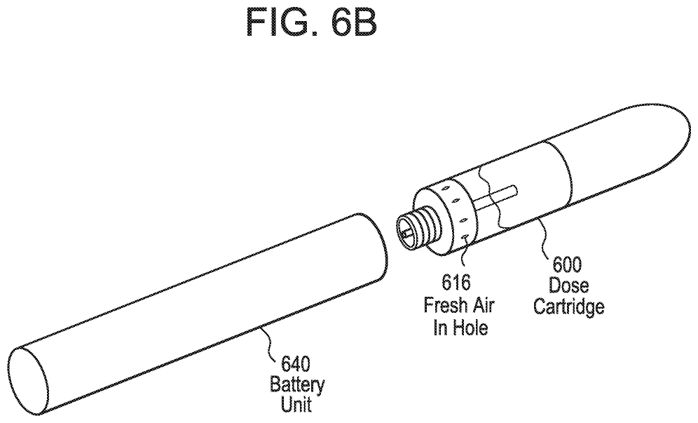

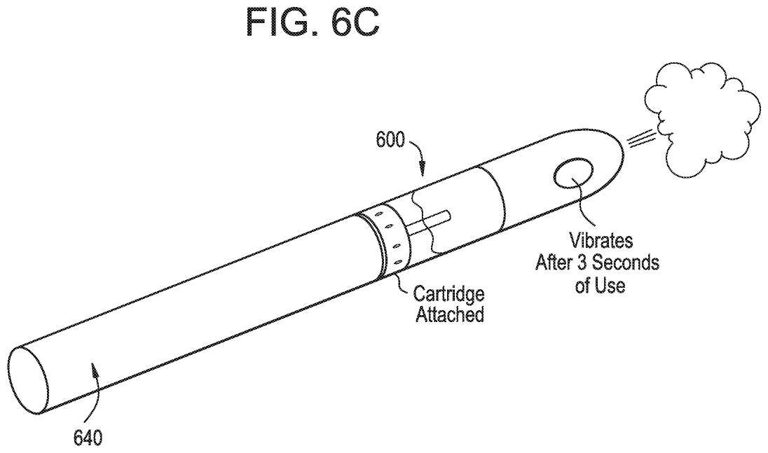

FIGS. 6A-6B illustrate an inhalation device 600 according to another embodiment of the disclosure, where the inhalation components are provided in cartridge form, and referred to herein as an “inhalation cartridge” or “dosing cartridge”. It is noted that any of the preceding-described devices may also be provided in cartridge form; this particular embodiment describing one such arrangement for a particularly economical implementation. As used herein, “cartridge form” simply means that the inhalation device is configured such that the battery unit is detachably provided from the remaining elements, and typically connectible to the inhalation cartridge by a standardized connection, such as the well-known “510 thread”, “710 thread” or similar standard connection. The inhalation cartridge 600 includes a printed control board 602 having a processor 604 for controlling various operations and components of the inhalation cartridge 600. The PCB 602 can include a memory for storing data and a transmitter for transmitting data to external devices. The type of transmitter can take many forms, including; bluetooth, WIFI, cellular, near field radio, transponder and others. Applicant's related applications P245431 and P245432, incorporated herein by reference, include the details of these and other such “connected device” implementations. The processor 604 is configured to control various components including an on/off switch or sensor 601, a timer 606 and a heater 612. The inhalation cartridge 600 also includes an inlet 616, an outlet 608, a reservoir tank 610, a battery connection portion 625, an indicator 614 and the mouthpiece 617 having a channel extending to the outlet 608. Inhalation cartridge 600 may also incorporate various features and functions of the embodiments described above. For example, this cartridge can incorporate various sensors to turn on the heater 612 when inhalation by a user is detected, i.e., using pressure sensors, volume flow sensors or the like as described in the embodiments above. The cartridge can also be used together with battery units either having no separate power switches, or those having their own power buttons or other types of initiation mechanisms. The inhalation cartridge device, through processing of dose amounts, can also provide indications to a user about the amount or dose that is cumulatively delivered.

While this embodiment shows the channel being formed in a mouthpiece 617, this portion may be embodied in the form of a nose inhalation device to permit the user to inhale the dose through their nasal passages. This can be particularly useful for administering decongestants and antihistamines to a user.

The reservoir tank 610 tank can be configured for refilling, either by the user or the manufacturer. The reservoir can be configured to accept and dispense liquid, and with non-liquid or semi-liquid substances; such as dried herbs, pastes, oils, powders, resins, butters, creams, and other forms.

In this embodiment, the cartridge is configured to be attached to a battery (not shown) using the battery connection 625 to provide power to the inhalation cartridge 600. The battery connector 625 shown in FIG. 6A has a standard 510 thread connection, but this may be configured as a standard 710 thread or other connection. This permits a user to easily interchange the battery with those complying with the 510 or 710 standard, or conversely, to convert a standard vaporization inhaler into a dosage-metered inhaler. The connector 625 may be configured with other thread counts or connecting methods. FIG. 6B shows the inhalation device 600 where the dosing cartridge is separated from a battery unit 640. FIG. 6C shows the dosing cartridge connected with the battery unit. In this embodiment, the battery unit 640 has female thread connections configured to mate with, for example, the standard 510 or standard 710 connector of the dosing cartridge, though the reverse configuration is also possible.

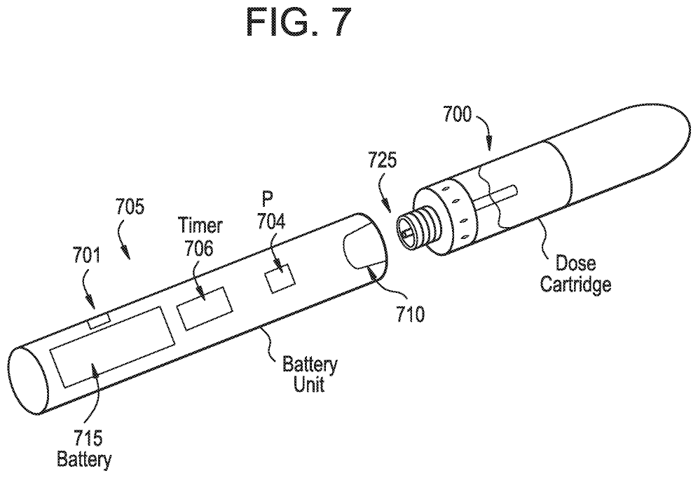

The inhalation cartridge 600 according to this embodiment is configured to use a processor 604 and a timer 606 (which may be part of or separate from the processor) to control the amount of time the heater 612 is activated when a user inhales through the cartridge. Specifically, when the user begins to inhale through the device, a sensor (volumetric or pressure) as described in the embodiments above, detects the inhalation and the processor 604 starts the timer 606 and heater 612 to vaporize the substance within the reservoir tank 610. In this manner, the processor and timer function to control the time duration over which the heater 606 is activated. When this time duration reaches a predetermined time limit, the processor 604 deactivates the heater 612 to end the vaporization of any further material from the reservoir tank 610. When the heater 612 is deactivated, the processor can also cause the indicator 614 to output a signal to the user that vaporization has ended. This output signal can be configured to provide indications to the user in accord with methods described with the embodiments described above, e.g., vibration, sound or light. The indicator 614 can also be configured as a dosage session indicator as described in the embodiments above. If the particular cartridge is not equipped with a volumetric or pressure sensor and associated switch as described above, the battery can be activated by other means, typically by using a button or other actuator on the battery itself. In this case, the timer and any controller/controls therefor may be accommodated within the battery unit, as described below with respect to FIG. 7, and in other embodiments in Applicant's copending application no. (dkt A247637) which is herewith incorporated by reference.

This predetermined timing can be, for example, 3 seconds in duration based on empirical evidence with known materials, vapor densities, heater characteristics and flows. However, this timing can be varied depending on the substance to be vaporized and the amount/concentration/strength of drug, etc., contained in the substance, and in some embodiments, a drug-vapor-density factor (mg of drug/cm³ of vapor) can additionally be used to determine the quantity of drug consumed.

Alternatively, the processor 604, instead of deactivating the heater 612, may continue operation of the heater 612 and cause the indicator 614 to provide an indication to the user that the desired dose has been delivered. Upon receiving this indication, the user can then cease inhalation to limit the amount of substance inhaled and cause the battery to be disconnected. In case of use with battery units having their own push button or other power switch or switching mechanisms, the user may need to operate this element in addition to inhaling, to initiate heater operation although cessation of the inhale will disconnect the battery in this case also.

The predetermined time threshold may be set in advance, or alternatively, the predetermined time threshold may be variable based on considerations such as the initial temperature of the heater, the type or concentration of material to be vaporized in the reservoir, etc. As the materials containing the various substances may vaporize at different rates, the inhalation cartridge 600 may incorporate a switch, slider or dial device, for example, to enable a user to select a type of material, or an intended predetermined timing, to maintain consistency of the dose. This also allows different doses of the same material, or the same dose of different materials to be administered with good precision. If desired, the switch, slider or dial device may include markings or graduations indicating desired dose, rather than units of time.

The processor 604 can determine a total dosing amount based on accumulating the amounts of doses delivered by the inhalation device 600. In the case where a predetermined heater on-time threshold is used to deliver the dose amount, the processor 604 can update the accumulated dose amount (by day, week, etc.) and store this in the memory of the PCB 602. This dosage amount can be communicated externally via the transmitter of the PCB 602. Alternatively, each time a dose is delivered by the inhalation device 600, an indication that a dose has been delivered may be transmitted to an external device to permit that device to track the total dose or usage.

Additionally, as the initial temperature of the heater may vary, it is also possible to modify the set predetermined limit to compensate for the time required for the heater to reach a vaporization temperature for the material in the reservoir. For example, if the heater of inhalation cartridge has been recently activated, the time to reach the vaporization temperature may be less than where the inhalation device has been idle, and therefore, at a lower initial temperature. Similarly, if the device is operated at a very low ambient temperature, for example, the heater may require additional time to reach the vaporization point. Thus, the processor 604 may be configured to adjust the predetermined limit by increasing the time of activation, or decreasing the time of activation to further ensure precision of the dosing amount.

While not shown, the inhalation cartridge 600 may incorporate a thermocouple to measure the temperature of the heater 612 to make adjustments to the predetermined time limit based on the current measure of the heater temperature. The processor 604 in combination with a thermocouple can effectively adjust for different external conditions, such as use in extremely cold or hot conditions. Therefore, the dosing precision can be further increased to permit proper dosing at temperatures below freezing and temperatures experienced within, for example, a sun heated enclosure.

According to another variation, the inhalation cartridge 600 processor 604 may be configured to incorporate data from the timer and from the various sensors described in the embodiments detailed above to calculate the dosage information, i.e., by using the sensor 108 (optosensor) change and vapor intensity/density in combination with the timer information to calculate a dosage amount. Thus, the vapor intensity per unit time can be integrated over a time period to calculate dosage. Alternatively, as per above, the dosage can be determined based on an accumulation of time over which the heater is activated. This information may be stored in a memory or other storage unit associated with the inhalation device and/or transmitted to an external device.

FIG. 7 illustrates a battery unit 700 according to another embodiment of the disclosure. This battery unit 700 includes a battery 715, a timer 706 and a battery connection 725. This configuration can be used in combination with any inhalation device that is connectable to the battery unit 700 via the battery connection 725. This battery connection may include a threaded connection, and this connection can be configured to comply with, for example, the 510 standard or the 710 standard. Additionally, other battery connections can be used as well.

Under one configuration, the battery unit 700 can be configured such that the timer 706 determines when battery current is being drawn by an attached inhalation device to measure the time that a heater is activated in the inhalation device. The timer can operate in conjunction with circuitry that cuts the power supplied to the inhalation device after heater current is drawn for a predetermined time to control a dosage amount similar to the embodiment of FIG. 6. The battery unit may also include a switch or dial 701 to permit a user to set the predetermined time of current supply to control the dosage amount. Accordingly, any inhalation device can be converted, by use of this battery unit, into a device that can control a dosage amount of the inhalation device.

Additionally, the battery unit 700 may include a power switch (not shown), and a processor 704 operable together with the timer 706 to control the power delivered by the battery 715 via switches or the like. The processor or timer may receive user input from the switch or toggle 701, to adjust the timer 706 duration. The processor 704 can further include the processing capabilities of the embodiment of FIG. 6 and associated sensing elements to provide enhanced dosage control as described above. The timer can also be adjusted based on other factors such temperature, etc. as described in prior embodiments.

In another embodiment, the inhalation devices described herein can be connected to a mobile device such as a smartphone or tablet and interfaced with a software application. The software application can record the doses that the user has inhaled and record the user's dosage experience. This information can be analyzed by the software to track and optimize the user's experience with the substance inhaled. To help improve analysis, the user could also enter personal information such as ailments, pains, weight and food intake. The information recorded can be used to accurately monitor a user's intake details and may be submitted to a doctor for review and/or improvement.

The application could also connect with other users via the internet. This could be used to share experiences, receive recommendations, and network with a community of users. The application may also be used as an ecommerce platform to purchase dosage capsules, or vaporizer equipment. The platform could offer specific substances based on a user's rated experience. Another enhanced use might be finding other users within geographic locations that may allow for social interactions and meetings. These enhanced services may be integrated with others over the internet.

The vaporizer device could also be locked by the user via the application. This could be used as a safety feature against undesired use (by children or others). There could be locking customizable lock setting to enhance safety or limit usage for those with low selfcontrol. In these timed embodiments disclosed herein, the timer/processor itself may be used to impose usage limits by preventing battery connection to the heater for a prescribed period of time, after the completion of an inhalation session.

While embodiments have been described herein with a wick and heating element, other suitable methods of vaporizing a substance could be utilized without departing from the scope of this disclosure. For example, the substance to be vaporized could be placed in a chamber or oven. The oven can be a small cup made of metal, where a user could place the substance. The oven would then heat up and vaporize the substance. Any vapor produced can exit the oven and flow to the user when the user inhales

While embodiments have been illustrated and described herein, it is appreciated that various substitutions and changes in the described embodiments may be made by those skilled in the art without departing from the spirit of this disclosure. The embodiments described herein are for illustration and not intended to limit the scope of this disclosure.

What is claimed is:

1. An inhalation device for inhaling a vaporized substance comprising:
a controller configured to activate a heater to vaporize a substance contained in a reservoir to create the vaporized substance;
a channel through which the vaporized substance can flow to a user,
a timer that measures the duration of activation of the heater after the heater is activated,
wherein the inhalation device is configured to deactivate a battery when the amount of time that the heater has been activated reaches a predetermined duration.

2. The inhalation device of claim 1, further comprising a means permitting the user to set the predetermined duration.

3. The inhalation device of claim 1, wherein the controller adjusts the predetermined duration based on a temperature of the heater at a time when the heater is first activated.

4. The inhalation device of claim 1, further comprising an indicator, wherein the indicator informs the user when a dose of the substance has been inhaled.

5. The inhalation device of claim 6, wherein the indicator is an audio signal, a visual signal or a vibration.

6. The inhalation device of claim 1, further comprising a mouthpiece through which said channel passes.

7. The inhalation device of claim 1, further comprising a nasal cannula through which said channel passes.

8. The inhalation device of claim 1, further comprising a temperature detector to detect a temperature of the heater.

9. The inhalation device of claim 1, wherein the predetermined duration is adjusted based on an initial detected temperature of the heater.

10. The inhalation device of claim 1, wherein the predetermined duration is adjusted based on a time lapse between a current activation of the heater and a prior activation of the heater.

11. The inhalation device of claim 1, further comprising a battery connector to connect the inhalation device to the battery.

12. The inhalation device of claim 1, wherein the battery connector comprises a 510 standard or a 710 standard threaded connection.

13. A device for converting an unmetered vaporization type inhaler into a dosimetric metered inhalation device, comprising:
an inhalation cartridge comprised of the device of claim 1,
the cartridge further comprising a battery connector fitting a removable battery of said unmetered vaporization type inhaler.

14. A battery cartridge configured to connect to an inhalation device; the battery cartridge comprising:
a battery connector configured to connect to an inhalation device;
a battery configured to supply power through the battery connector;
a timer unit that determines an amount of time that the battery supplies power,
wherein the timer unit is configured to stop the battery from supplying power through the battery connector when the amount of time reaches a predetermined duration corresponding to an amount of substance inhaled using the inhalation device.

15. The device of claim 14, further comprising an input device to permit a user to adjust the predetermined duration.

16. The device of claim 15, wherein the predetermined duration is auto-adjusted based on a time lapse between a current activation of the battery and a prior activation of the battery.

17. The device of claim 14, where the battery connector comprises a 510 standard or a 710 standard threaded connection.

18. An inhalation device for inhaling a vaporized substance comprising:
a vaporizer configured to vaporize a substance to create the vaporized substance;
a channel through which the vaporized substance can flow,
a timer that measures an amount of time that the substance is vaporized,
wherein a dosage amount of the vaporized substance is determined based on the measured amount of time and vaporization is ceased in response to the dosage being determined to have been delivered.
